(19) United States
(12) Patent Application Publication
(10) Pub. No.: US 2006/0271718 A1
(43) Pub. Date: Nov. 30, 2006

(54) Method of preventing error propagation in a PCI / PCI-X / PCI express link

(76) Inventors: Bruno DiPlacido JR., Westborough, MA (US); Joseph Murray, Scottsdale, AZ (US); Victor Lau, Marlboro, MA (US); Marc Goldschmidt, Scottsdale, AZ (US); Eric J. DeHaemer, Shrewsbury, MA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/139,222

(22) Filed: May 27, 2005

(51) Int. Cl. G06F 13/24

(52) U.S. Cl. 710/263

(57) ABSTRACT

An embodiment is a method and apparatus to prevent the propagation of an error in a transmission from an I/O processor of a peripheral device to a host in a computer system utilizing a PCI, PCI-X, or PCI Express link. An embodiment detects an error in a transmission, may shut down the transmission path, and further intercepts the confirmation message before the confirmation message can be sent to the host

### FIELD

Embodiments of the invention relate a method of preventing error propagation in a computer bus, and in particular in a PCI, PCI-X, or PCI Express link.

### BACKGROUND

As is known in the art, a bus is a subsystem that transfers data and/or power between and among various computer components or between and among multiple computers over the same set of interconnect wires. Various historical bus approaches have addressed the need for a processor to communicate with memory and with peripheral devices, sharing resources, and matching clock speeds and communication mechanisms among the various members of the bus.

One such early approach was Inte's Peripheral Component Interconnect (PCI) bus that emerged in its first form in the early 1990s. At the time of its development, the PCI bus was designed to provide peripheral devices connected thereto fast access to each other and to system memory. Further, and in particular during the nascent stages of PCI bus implementation, the host processor could access the peripheral devices at speeds approaching the native speed of the host processor.

A second generation approach, PCI Extended, or simply PCI-X, updated the PCI specification by essentially doubling the bus width from 32 to 64 bits and increasing the basic clock rate. The combination of increased bus width and clock rate substantially increased the theoretical overall throughput of the bus; however, such performance increases were and still are substantially offset, at least in terms of commercial practicability, by the relative expense of implementing the PCI-X bus architecture. For example, the faster bus speed and widths were accompanied by increased noise sensitivity and crosstalk respectively. Further, the increased bus width contributed to a greater load on the bus placed by each peripheral, further injecting noise to an already noise sensitive bus. Finally, each peripheral device required 32 more pins, contributing to increased cost of manufacturing the peripheral device cards and the motherboards to which they were attached. In summary, the PCI-X bus offered increased throughput versus first generation PCI, but simultaneously amplified some of the PCI bus's inherent problems.

As the need for increased communication speed among the various peripheral devices of a computer system continued to increase, so too did the need for an bus that could support and manage higher bandwidth communication. A third generation approach is PCI Express. Unlike the multi-drop parallel bus of PCI and PCI-X, PCI Express replaces the multi-drop bus with a switch that, in a point-to-point bus topology, is the single shared resource by which all the devices attached thereto communicate. Instead of collectively arbitrating for bus use, PCI Express provides each device with a direct and exclusive access to the switch. Said differently, each device in the PCI Express arrangement has its own bus, or link, to the switch. The switch then establishes point-to-point connections and routes bus traffic.

### BRIEF DESCRIPTION OF THE DRAWINGS

FIG. 1: illustration of a PCI Express bus and a plurality of peripherals coupled thereto

FIG. 2: illustration of a PCI Express bus including a storage I/O subsystem

FIG. 3: illustration of an I/O interface of an embodiment

FIG. 4a: illustration of a method flowchart of an embodiment indicating the detection, flushing, and reporting of an error

FIG. 4b: illustration of a method flowchart of another embodiment indicating the detection, flushing, and reporting of an error

FIG. 5: illustration of a computer system including the I/O interface of an embodiment

### DETAILED DESCRIPTION

Embodiments of a method and apparatus for preventing error propagation in a PCI/PCI-X/PCI Express link will be described. Reference will now be made in detail to a description of these embodiments as illustrated in the drawings. While the embodiments will be described in connection with these drawings, there is no intent to limit them to drawings disclosed herein. On the contrary, the intent is to cover all alternatives, modifications, and equivalents within the spirit and scope of the described embodiments as defined by the accompanying claims.

Simply stated, an embodiment is a method and apparatus to prevent the propagation of an error in a transmission from an I/O processor of a peripheral device to a host in a computer system utilizing a PCI, PCI-X, or PCI Express link. An embodiment detects an error in a transmission, may shut down the transmission path, and further intercepts the confirmation message before the confirmation message can be sent to the host.

In a traditional scheme, an I/O processor coupled to a bus transmits data to a host. After the data transfer, the I/O processor sends a confirmation message to the host to ensure that the host received the transmission. Said alternatively, the transfer from the I/O processor to the host loads the buffers in the host memory with the data of the transfer. Thereafter, the confirmation updates the queue pointer to reference the data of the transmission stored in the host buffer. That confirmation, however, is generally a posted message in that the I/O processor is not aware whether or not or when the confirmation message is received by the host. Accordingly, if there is an error in the path, the originating I/O processor would have no indication that the error existed. Rather, it would simply have an indication that the confirmation message was sent. Multiple errors can propagate rapidly as a result as subsequent transmissions occur.

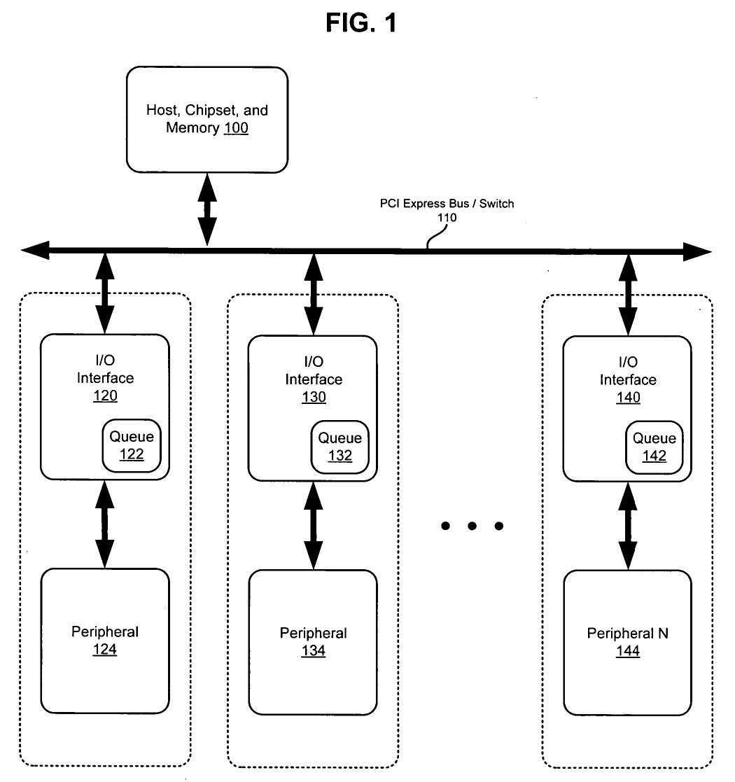

FIG. 1 illustrates a PCI Express bus and a plurality of peripherals coupled therewith. For example, a host, chipset, and memory 100 are coupled to a PCI Express bus/switch 110. Also coupled to the PCI Express bus/switch is a peripheral 124 via PCI Express interface 120 including queue 122. Similarly, peripheral 134 is coupled to the PCI Express bus/switch 110 via PCI Express interface 130 including queue 132. Still further, peripheral N is coupled to the PCI Express bus/switch 110 via PCI Express Interface 140 including queue 142, indicating that many peripherals may be coupled to the PCI Express bus/switch 110. Though described in particular with reference to PCI Express bus/switch 110, it is to be understood that the bus operation and topology may also accord to PCI or PCI-X.

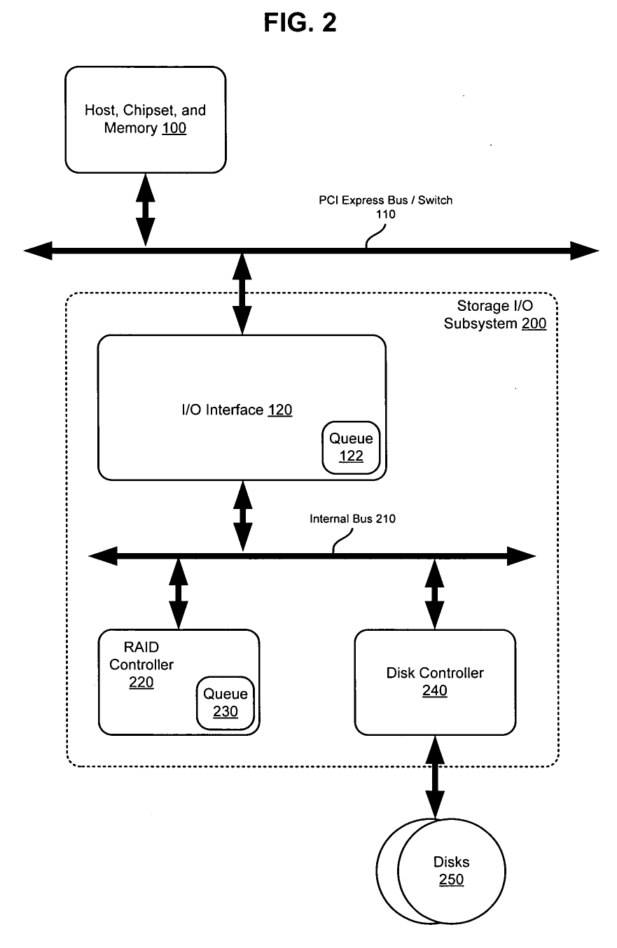

FIG. 2 illustrates a specific example of a peripheral device coupled to the PCI Express bus/switch 110. The storage I/O subsystem 200 (the application of, for example, peripheral 124) includes an I/O interface 120 of an embodiment and a queue 122 coupled to a RAID controller 220 (the RAID controller also including a queue 230) and a disk controller 240 via an internal bus 210. As known in the art, RAID equates to a redundant array of independent disks and refers to a method of error and risk reduction by maintaining redundant instances of data on multiple disks (e.g., striping and/or mirroring). Further connected to the disk controller 240 are disks 250. Though illustrated as multiple disks, it is to be understood that disks 250 are representative of both a single disk and multiple disks.

It is to be further understood that while detailed with reference to a storage I/O subsystem, the peripherals 124, 134, and 144 may be any peripheral type that may be coupled to a PCI, PCI-X, or PCI-Express bus including but not limited to audio peripherals, video peripherals, graphics adapters, networking adapters, bus adapters, and bus bridges as is known in the art.

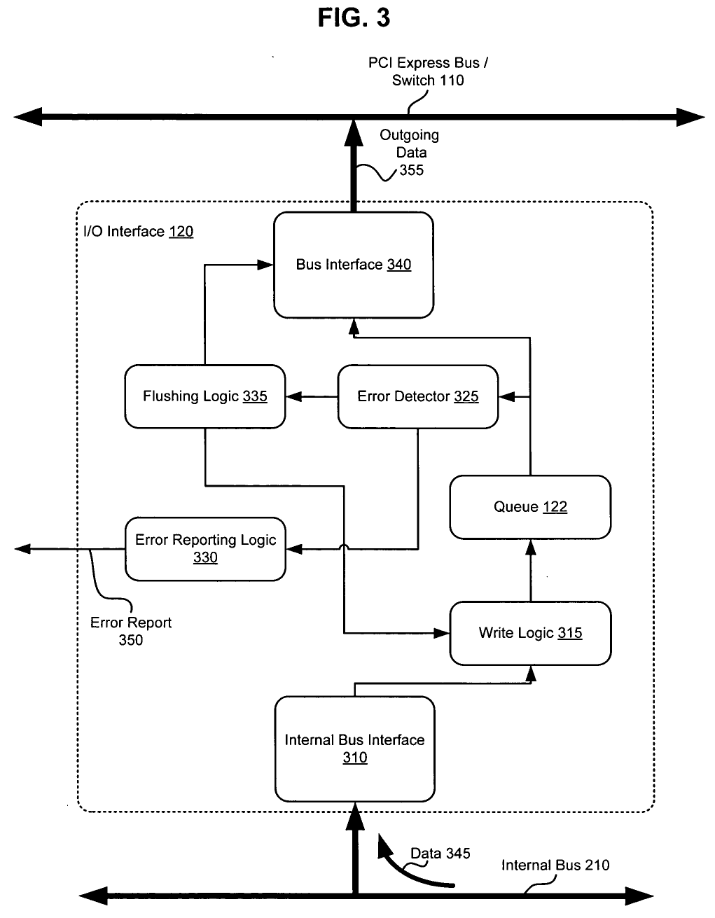

FIG. 3 illustrates the detail of the I/O interface 120 of FIG. 1 and FIG. 2 including the error detection, reporting, and flushing logic of an embodiment. In an embodiment the I/O interface 120 is coupled to the internal bus 210 with an internal bus interface 310 and to the PCI Express bus/switch 110 with a bus interface 340. The internal bus interface is thereafter coupled to write logic 315. The write logic 315 tags any incoming data 345 transaction with an index and writes the transaction (including the index) in the queue 122. In an embodiment the index includes an address of a source of the transaction, an address of the destination of the transaction, and an I/O number to identify the transaction. The index serves to identify the transaction should an error be subsequently detected in the transaction. The queue 122 is thereafter coupled to the bus interface 340. A transaction written to the queue 122 can then be released through the bus interface 340 to the PCI Express Bus/switch and subsequently to its destination.

Also coupled to the output of the queue 122 is an error detector 325 to detect errors in the queue's 122 effluent transaction. The error detector 325 detects errors in the queue's 122 effluent transaction by any error detection method known in the art. For example, parity protection, error correction code (ECC), or cyclical redundancy checking (CRC). In an embodiment the error detector 325 detects an error in the queue's 122 effluent transaction by checking parity.

The error detector 325 is further coupled to error reporting logic 330. When the error detector 325 detects an error in the transaction as described above, it causes the error reporting logic 330 to generate an error report 350. The error reporting logic 330 can, based on the index generated by the write logic 315 for a particular transaction, uniquely identify the transaction to both monitor the occurrence of the error as well as initiate a recovery procedure for those errors (i.e. soft errors) that are recoverable.

In addition to the error reporting logic 330, the error detector 325 is further coupled to flushing logic 335. In addition to triggering the error reporting logic 330 as introduced, the error detect 325, upon detecting an error in the queue's 122 effluent transaction, further triggers the flushing logic 335. The flushing logic 335 operates, by controlling the bus interface 340, to block a confirmation message from continuing upstream. More specifically, by controlling the bus interface 340, the flushing logic 335, following the detection of an error by error detector 325, interrupts the transmission path between the queue 122 and the PCI Express bus/switch 110 and intercepts the confirm message so that the destination of the transaction will ignore the transaction.

In addition to interrupting the transmission path between the queue 122 and the PCI Express bus/switch 110, the flushing logic 335 is coupled to the write logic 315 and operates to flush the queue 122 upon the error detect 325 detecting an error. By flushing the queue 122 of all transactions, the flushing logic prevents error propagation by preventing subsequent transactions from being tainted by the error.

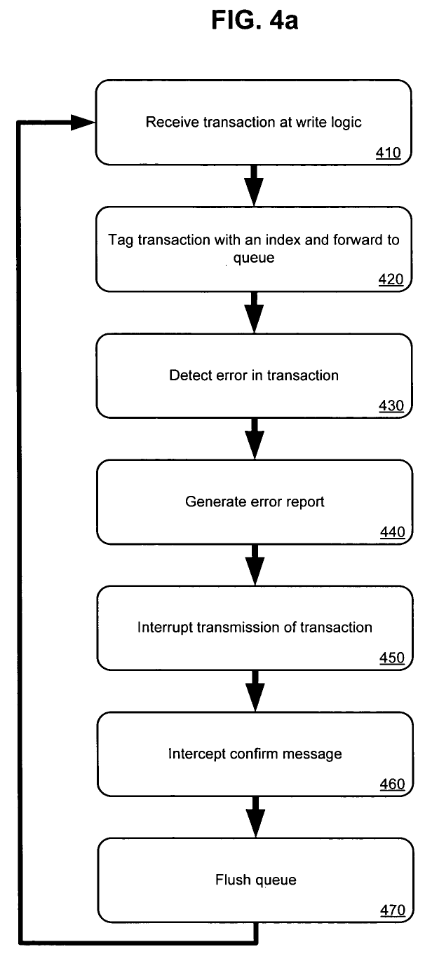

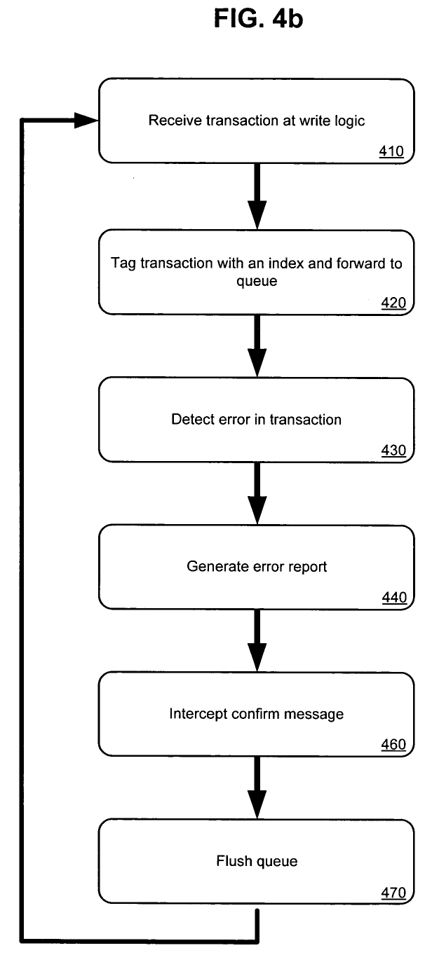

FIG. 4a illustrates a flow chart of a method of an embodiment. The method begins when, for example, data 345 by way of internal bus 210 reaches the I/O interface 120 through internal bus interface 310. Thereafter, the data 345 transaction is received at the write logic, 410. Having received the transaction, the write logic tags the transaction with an index and forwards the transaction to the queue, 420. When the queue releases the transaction, an error in the transaction is detected, 430. If an error is not present, the transaction proceeds to the PCI Express bus/switch as outgoing data 355 through the bus interface 340. If an error is detected, an error report is generated, 440. Further, the transmission of the transaction (e.g., through bus interface 340) is interrupted, 450, and the confirm message for the transaction is intercepted, 460. Thereafter, the queue is flushed, 470.

FIG. 4b illustrates a flow chart of a method according to another embodiment. Like numbered portions of the method of FIG. 4b reflect the method illustrated by FIG. 4a. In an embodiment, in particular for an embodiment utilizing a PCI-X bus, the transmission of the transaction will not be interrupted. Said alternatively, the method of FIG. 4b omits the process block 450 of FIG. 4a. Further, for an embodiment utilizing the PCI Express bus, the transmission of the transaction may optionally be interrupted, or only interrupted in certain circumstances in which case either the FIG. 4a method, FIG. 4b method, or both methods may apply.

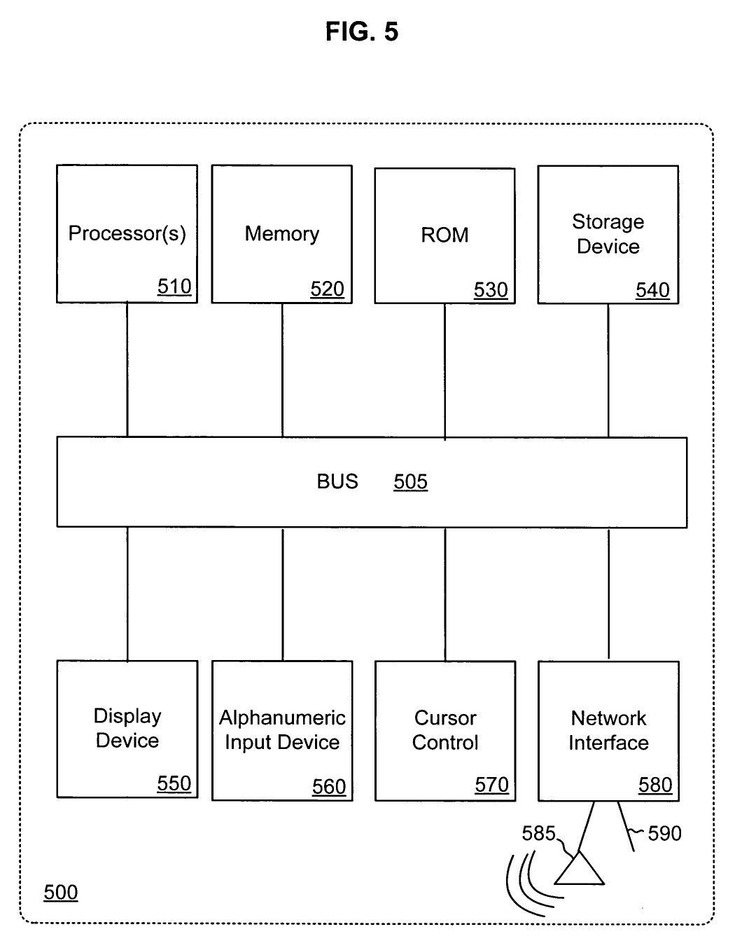

FIG. 5 is a block diagram of one embodiment of an electronic system. The electronic system illustrated in FIG. 5 is intended to represent a range of electronic systems (either wired or wireless) including, for example, desktop computer systems, laptop computer systems, cellular telephones, personal digital assistants (PDAs) including cellular-enabled PDAs, set top boxes. Alternative electronic systems may include more, fewer and/or different components.

Electronic system 500 includes bus 505 or other communication device to communicate information, and processor 510 coupled to bus 505 that may process information. While electronic system 500 is illustrated with a single processor, electronic system 500 may include multiple processors and/or co-processors. Electronic system 500 further may include random access memory (RAM) or other dynamic storage device 520 (referred to as main memory), coupled to bus 505 and may store information and instructions that may be executed by processor 510. Main memory 520 may also be used to store temporary variables or other intermediate information during execution of instructions by processor 510.

Electronic system 500 may also include read only memory (ROM) and/or other static storage device 530 coupled to bus 505 that may store static information and instructions for processor 510. Data storage device 540 may be coupled to bus 505 to store information and instructions. Data storage device 540 such as a magnetic disk or optical disc and corresponding drive may be coupled to electronic system 500.

Electronic system 500 may also be coupled via bus 505 to display device 550, such as a cathode ray tube (CRT) or liquid crystal display (LCD), to display information to a user. Alphanumeric input device 560, including alphanumeric and other keys, may be coupled to bus 505 to communicate information and command selections to processor 510. Another type of user input device is cursor control 570, such as a mouse, a trackball, or cursor direction keys to communicate direction information and command selections to processor 510 and to control cursor movement on display 550.

Electronic system 500 further may include network interface(s) 580 to provide access to a network, such as a local area network. Network interface(s) 580 may include, for example, a wireless network interface having antenna 585, which may represent one or more antenna(e). Network interface(s) 580 may further include a cable 590, which may represent one or more Ethernet cables, coaxial cables, and/or fiber optic cables. In one embodiment, network interface(s) 580 may provide access to a local area network, for example, by conforming to IEEE 802.11b and/or IEEE 802.11g standards, and/or the wireless network interface may provide access to a personal area network, for example, by conforming to Bluetooth standards. Other wireless network interfaces and/or protocols can also be supported. In addition to, or instead of, communication via wireless LAN standards, network interface(s) 580 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Though not illustrated, it is understood that communication between the various devices (e.g., processor(s) 510, memory 520, ROM 530, storage device 540, display device 550, alphanumeric input device 560, cursor control 570 and network interface 580) via the bus 505 is governed by I/O interfaces of an embodiment as explained above to mitigate the propagation of errors by detecting, reporting, and flushing errors as they occur.

One skilled in the art will recognize the elegance of an embodiment in that it prevents error propagation through a PCI, PCI-X, or PCI Express bus.

What is claimed is:

1. A method comprising:
tagging an I/O transaction with an index;
queuing, with a queue, the I/O transaction;
detecting an error in the I/O transaction; and
generating an error report in response to the detection of a error.

2. The method of claim 1 further comprising:
interrupting the transmission of the I/O transaction.

3. The method of claim 1 further comprising:
intercepting a confirm message for the I/O transaction.

4. The method of claim 2 further comprising:
flushing the queue.

5. The method of claim 1 wherein the index includes one or more of an address of a source of the transaction, an address of a destination of the transaction, or an I/O number to identify the transaction.

6. An apparatus comprising:
a write logic to tag a data transaction with an index;
a queue coupled to the write logic to queue the tagged data transaction; and
an error detector coupled to the queue to detect an error in the tagged data transaction.

7. The apparatus of claim 6 further comprising:
an error reporting logic coupled to the error detector to generate an error report upon detection of an error by the error detector.

8. The apparatus of claim 7 further comprising:
a flushing logic coupled to the error detector, the flushing logic to intercept a confirm message corresponding to the tagged data transaction.

9. The apparatus of claim 8, the flushing logic to further to interrupt a transmission of the tagged data transaction.

10. The apparatus of claim 9, the flushing logic to further flush the queue.

11. An article of manufacture comprising:
a machine-accessible medium including instructions that, when executed by a machine,
cause the machine to perform operations of:
tagging an I/O transaction with an index;
queuing, with a queue, the I/O transaction;
detecting an error in the I/O transaction; and
generating an error report in response to the detection of a error.

12. The article of manufacture of claim 11, the machine-accessible medium further including instructions that, when executed by the machine, cause the machine to perform the operation of:
intercepting a confirm message for the I/O transaction.

13. The article of manufacture of claim 12, the machine-accessible medium further including instructions that, when executed by the machine, cause the machine to perform the operation of:
interrupting the transmission of the I/O transaction.

14. The article of manufacture of claim 13, the machine-accessible medium further including instructions that, when executed by the machine, cause the machine to perform the operation of:
flushing the queue.

15. The article of manufacture of claim 14 wherein the index includes one or more of an address of a source of the transaction, an address of a destination of the transaction, or an I/O number to identify the transaction.

16. A computer system comprising:
a bus;
a data storage device coupled to said bus;
a processor coupled to said data storage device, said processor operable to receive instructions which, when executed by the processor, causes the processor to
tag an I/O transaction with an index,
queue the I/O transaction,
detect an error in the I/O transaction,
generate an error report in response to the detection of a error, and
a network interface coupled to the bus; and
a fiber optic cable coupled to the network interface.

17. The computer system of claim 16, the instructions further comprising instructions to: interrupt the transmission of the I/O transaction.

18. The computer system of claim 17, the instructions further comprising instructions to: intercept a confirm message for the I/O transaction.

19. The computer system of claim 18, the instructions further comprising instructions to flush the queue
